(19) United States
(12) Patent Application Publication
(10) Pub. No.: US 2008/0163341 A1
(43) Pub. Date: Jul. 3, 2008

(54) MULTI-VECTOR ELECTRONIC MAIL

(75) Inventors: Stewart L. Adams, Durham, NC (US); Matthew B. Griffith, Raleigh, NC (US); Michael S. Mettler, Durham, NC (US); Scott D. Ruppert, Durham, NC (US)

Correspondence Address: Driggs, Hogg, Daugherty & Del Zoppo Co., L.P.A., 38500 CHARDON ROAD, DEPT. LEN, WILLOUGHBY HILLS, OH, 44094, US

(73) Assignee: Lenovo (Singapore) Pte. Ltd., New Tech Park (SI)

(21) Appl. No.: 11/625,854

(22) Filed: Jan. 23, 2007

Related U.S. Application Data
(60) Provisional application No. 60/882,661, filed on Dec. 29, 2006.

(51) Int. Cl. H04L 9/32; G06F 15/16

(52) U.S. Cl. 726/4; 709/206

(57) ABSTRACT

A system includes a processor that separates an email message into a public message component and at least one private message component and memory for storing the public message component and the at least one private message component. The email message includes a public message block having a public message for a plurality of public recipients and at least one private message block having a private message for at least one private message recipient, and the at least one private message recipient is a subset of the plurality of public recipients. The public message component includes the public message from the public message block and the private message includes the public message and the at least one private message from the public message block and the private message block.

### CROSS REFERENCE TO RELATED APPLICATIONS

This application claims priority of provisional patent application Ser. No. 60/882,661, confirmation number 5013, filed Dec. 29, 2006, which is incorporated herein in its entirety by reference.

### TECHNICAL FIELD

The following generally relates to computing systems and, more particularly, to an electronic mail (email) system.

### BACKGROUND

Email has revolutionized the manner in which individuals, corporations, etc. correspond with each other. For example, traditionally one would draft a letter via pen or pencil on one or more sheets of paper. The individual would place the letter in an envelope, include the recipient's mailing address on the envelope, and affix a postage stamp on the envelope. The envelope would then be deposited in a mailbox or provided directly to a receiving post office. The receiving post office would sort the mail and provide the sorted mail to suitable delivery post offices. The delivery post office would then deliver the mail to the recipient. The recipient typically would receive the letter several days after it was received by the receiving post office. The above sequence would be repeated for each recipient, even when the same content is being provided to each of the recipients.

With email, the individual logs into an email account, types a message and includes any attachments, selects a recipient via an email address, and electronically sends the message with the click of a mouse. Commonly, the email message is received by the recipient's email account provider within moments after the email has been sent. In addition, the individual has the option to concurrently send the same email message to multiple recipients without having to draft more than one message by selecting multiple recipients. Thus, email may reduce drafting, sending, and delivery time, and the costs (e.g., materials, postage, travel to the post office or mailbox, etc.) associated therewith.

However, email has its limitations. For example, if the individual desires to limit the scope of the message conveyed to any one of the recipients, then all of the recipients receive a content-depleted email message or multiple different emails are drafted and sent to different recipients, in which case, the drafter is tasked with creating and sending multiple emails and is burdened with tracking the individual message threads.

### SUMMARY OF THE INVENTION

In one aspect, a system includes a processor that separates an email message into a public message component and at least one private message component and memory for storing the public message component and the at least one private message component. The email message includes a public message block having a public message for a plurality of public recipients and at least one private message block having a private message for at least one private message recipient, and the at least one private message recipient is a subset of the plurality of public recipients. The public message component includes the public message from the public message block and the private message includes the public message and the at least one private message from the public message block and the private message block.

In another aspect, a method includes separating an email message having a public message block and at least one private message block into a public message component that includes the public message block and at least one private message component, wherein each private message component includes the public message block and a corresponding private message block and storing the public message component and the at least one private message component on a computer readable medium.

In yet another aspect, a computer readable storage medium has computer program code stored therein. The program code includes instructions that when executed separate an email message having a public message block and at least one private message block into a public message component that includes the public message block, and at least one private message component, wherein each private message component includes the public message block and a corresponding private message block and stores the public message component and the at least one private message component in memory.

In still another aspect, a method includes providing computer executable program code to be deployed to and executed on a computer system. The program code includes instructions that when executed on the computer system parse an email message having a public message block and at least one private message block into a public message component that includes the public message block and at least one private message component, wherein each private message component includes the public message block and a corresponding private message block and stores the public message component and the at least one private message component on a computer readable medium.

Still further aspects are appreciated by those of ordinary skill in the art upon reading the following detailed description.

### BRIEF DESCRIPTION OF THE DRAWINGS

The drawings are for purposes of illustrating various aspects and are not limiting.

FIG. 1 illustrates an exemplary email system.

FIG. 2 illustrates an exemplary method for composing email.

FIG. 3 illustrates an exemplary method for conveying email.

FIG. 4 illustrates an exemplary method for receiving email.

FIG. 5 illustrates an exemplary method for replying to email.

FIG. 6 illustrates an exemplary method for forwarding email.

FIG. 7 illustrates an exemplary method for deleting email.

FIG. 8 illustrates an exemplary machine executing the email system.

### DETAILED DESCRIPTION

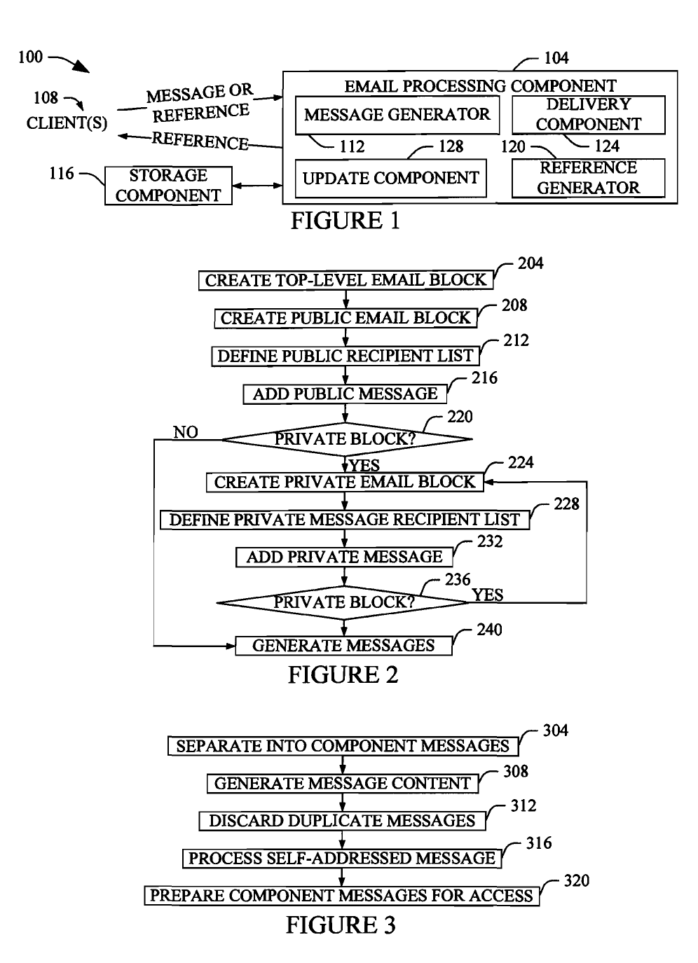

FIG. 1 illustrates a portion of an exemplary email system 100. In general, the email system 100 uses a multi-vectored approach in which a single email message having different sub-sections for different sets of recipients is concurrently sent to the different sets of recipients. Subsequent responses by a recipient(s), regardless of the number, are incorporated into a single thread, and the content of the email is saved only once.

The system 100 includes an email processing component 104 in communication with one or more clients 108. In this example, the email processing component 104 resides on a local or remote server. However, in other instances, the email processing component 104 resides on one of the clients 108.

The email processing component 104 includes a message generator 112 that separates a single multi-vectored email message from a user of a client 108 into a component public email message and at least one component private email message. As used herein, a multi-vectored email message is a single email message that has a public block and at least one private block. The public block includes a public message including text, graphics, pictures, attachments, etc. addressed to a set of public recipients, or the recipients of the single multi-vectored email message. The component public email message includes the content from the public block. Each private block includes a private message including text, graphics, pictures, attachments, etc. addressed to a set of private recipients, which are a subset of the set of public recipients. Each component private email message includes the content from the public block and any private block that is a subset of the corresponding private block. The component public and at least one private email messages are stored in memory such as a storage component 116.

A reference generator 120 generates a unique message identifier for the component public email message and each unique component private email message. A unique component private email message is a private message having a unique set of private recipients in that the component public message and any other component private message do not have the same set of message recipients. The public message identifier provides a reference to the stored component public message for public recipients, and each private message identifier provides a reference to a corresponding unique component private message for private recipients. The public and private unique references provide a recipient with access to the message. As noted above, a private message includes the public message and any subset private message of the private message. Thus, a recipient of a private message only needs a reference to the private message in order to be authorized to access the public and the private messages. An email delivery component 124 delivers the unique references to the appropriate recipients.

An update component 128 updates stored component messages. This includes adding content such as text, graphics, pictures, attachments, etc. to one or more of the stored messages upon a reply email from a recipient. Once updated, the stored component message is a single message that includes both the original message content and the new message content. The unique reference identifier maps the reply email to the initial unique email message. Such updating also includes removing a stored message from the storage component 116, for example, when each recipient of a message reference deletes the reference. Of course, the message can be retained, if desired, for example, for historical purposes even if all of its recipients have deleted the reference thereto.

It is to be appreciated that one or more of the email processing component 104, the message generator 112, the reference generator 120, the update component 128, and the delivery component 116 can be implemented in hardware, software, or a combination of hardware and software. For example, these components may be implemented as a single processor or multiple processors, including individual processors. In another example, these components may be implemented as computer readable instructions executed by a single processor or multiple processors, including individual processors. In yet another example, some of these components are implemented in hardware and some are implemented in software.

FIGS. 2-7 below provide a non-limiting example of the system 100 in operation. It is to be appreciated that the order of the below described acts is not limiting and, in other instances, may be different.

Initially referring to FIG. 2, at reference numeral 204, an email top-level block for a particular email message is created. This is invoked, for example, by a user desiring to draft an email. At 208, a public message block is created, and the public block is referenced in the top-level block. In this example, the public message block is automatically created upon the creation of the top-level block.

At 212, the drafter identifies recipients of the public message in the public block. Various techniques can be used to identify recipients. For example, the individual can type an email address or select a recipient from an electronic address book. In the illustrated implementation, the system is configured so that the drafter is automatically included as a recipient. Each of the recipients can be labeled as “visible” so that an identity (e.g., email address, alias, etc.) of the recipient is visible to the other recipients or “hidden” so that the identity of the recipient is not visible to the other recipients. In one instance, each selected recipient is a “visible” recipient by default and the individual has the option to change the recipient to a “hidden” recipient. A recipient may also be associated with a label that lets the recipient know that the message is being sent to them on a “for your information” or “FYI” basis.

At 216, the drafter inserts a public message, which may include text, a picture, graphics, and attachments, as well as other content.

At 220, the drafter has the option of creating a private branch within the email message by adding a first private block. If the drafter decides to include a private block, then at 224, a private block is created. Similar to the public block, a reference to the private block is included in the top-level block.

At 228, the drafter identifies recipients that will receive a private message inserted into the private block. Recipients for the private block are selected from the recipients of the public block and, as noted above, each recipient can be labeled as visible or hidden and/or FYI. The drafter is automatically included as a recipient of the private message.

At 232, the user provides the private message, which may include text, a picture, graphics, and attachments, as well as other content.

At 236, the user has the option of creating one or more additional private branches via one or more additional private blocks as described above in acts 220-232. At 240, after the user is finished adding content to the blocks, one or more component messages are generated for the public and private blocks as described in detail next in connection with FIG. 3.

Turning to FIG. 3, at reference numeral 304, the email processing component 104 parses or separates the email into component public and private messages. In general, there are 2ⁿ, wherein n is the number of private blocks, component messages for each multi-vectored email message.

By way of example, if there are no private messages (n=0), then there will be one component email message, the public message. If there is one private message (n=1), then there will be two component email messages, the public message and one private message. If there are two private message (n=2), then there will be four component email messages, the public message, a first private message to a first set of private recipients (or a first subset of public recipients), a second private message to a second and different set of private recipients (a second and different subset of public recipients), and a third private message to a third set of private recipients that is a super-set of both the first and second sets of private recipients, but still a subset of the public recipients. Other combinations for this case may exist, for example, when one or more of the private messages have the same set of recipients.

At 308, the content for each component message is generated. Each component public and private message includes a header and a unique identifier and the inserted message content. The content of each component private message also includes the unique identifier of the public message and any private messages included within the component private message. A private message is included within a component private message if the recipients of the private message are a subset of the recipients of the component private message. It is to be appreciated that by including the unique reference identifiers as such that the full message structure can be reconstructed by any user receiving any portion of the component message in the future. This also allows for self-repairing of a message if any portion of a message is lost, deleted, corrupted, or otherwise unavailable in the future.

At 312, duplicate (and unaddressed) component messages, if any exist, are discarded. A duplicate component message is one in which the recipients of the message are the same as the recipients for another component message. In this case, both component messages will include the same content for the same recipients. A more general way of saying this is that if a component message is a superset of another component message (a subset component message), then the subset component message is discarded since the content of the subset component message is delivered to the recipients via the superset message. As a result, the number of unique component messages is a function of the number of unique sets of private message recipients and is at most 2ⁿ.

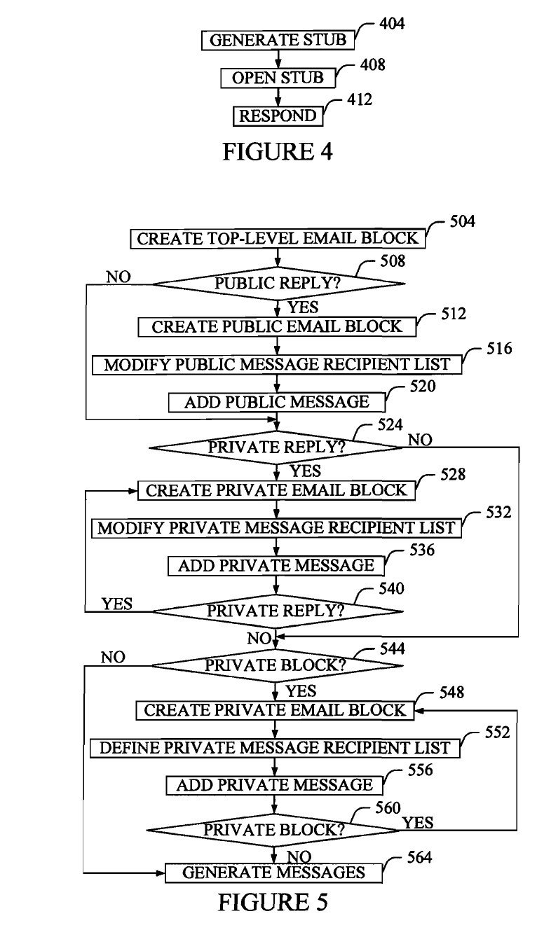

As noted above, the drafter is automatically included as a recipient. At 316, the self-addressed message is processed and stored. At 320, the remaining unique component messages are processed for access by corresponding recipients as described next in connection with FIG. 4. A reference counter can be used to keep track of the references to the messages. For instance, the counter can be incremented by one for each recipient. At any moment in time, the value of the counter indicates the number of recipients keeping a message active. As described below, the counter can be used to determine when, if at all, a message is deleted from storage.

Turning to FIG. 4, at reference numeral 404 a stub is generated to display a top-line discussion. Since every message is based on a top-level system block that includes references to all children blocks, the stub may exist only as a reference such as a title of the discussion and a reference to the top-level system block. Any message block received a subsequent time, for example, in a reply message, is not stored. Hence, each message component, including text, pictures, graphics, attachments, etc., is only stored once. This may result in a reduction of the size of any continued discussion.

At 408, a recipient opens the stub to view the discussion. Opening a stub launches the discussion system block, which reconstructs the parent-child hierarchy of all messages from within the discussion. As a consequence, two separate and different private block sets can be logically included in the same top-level discussion without a group of recipients being aware of the other group of recipients.

At 412, the recipient may respond to the message, for example, by replying to the message, forwarding the message, and/or deleting the reference to the message. These acts are described in greater detail below in connection with FIGS. 5-7.

FIG. 5 illustrates an exemplary approach for replying to a component message. At reference numeral 504, a new top-level block is created. The top-level block content includes references to the original top-level block, the public message for this reply, and any private messages included in the reply.

At 508, the replier is given the option to reply to the public message. If the replier decides to reply, then at 512 a public message block for a reply public message is created. This block includes a reference to the public block from the original message, which generally is not editable. Since the public block includes such a reference, and the top-level block also includes a reference to the received message (which also include a reference to the received public message), messages do not have to be referenced in more than one location. However, multiple references to a message typically only duplicate the reference to the message and not the message itself.

At 516, the replier has the option of adding or removing public recipients. Newly added public recipients receive all previous public messages. In addition, newly added public recipients can be deemed visible or hidden and/or FYI as described above. At 520, the replier enters a new public message. If no message is added, this public message block is discarded when generating unique emails.

At 524, the replier has the option to reply to any private block in which the replier is a recipient. If the replier chooses to do so, then at 528 a new private block is created. The newly created private block includes a reference to the original private block, which generally is not editable. As with new public blocks, multiple references to the newly created private block may exist.

At 532, the replier has the option of adding or removing recipients for the new private block. Newly added recipients will receive all previous public messages and all previous private messages within this block. In addition, newly added recipients can be deemed visible or hidden and/or FYI as described above. At 536, the replier enters the desired private message in the new private block. At 540, the replier has the option to reply to one or more other private messages, if any exist.

At 544, the replier is given the option to create a new private block. If the replier decides to create a new private block, then at 548 a new private block with a header, unique identifier, and content section is created. At 552, the replier defines the recipients of the new private block. As noted previously, the recipients for a private block are selected from and are a subset of the recipients of the public block.

At 556, the replier includes a message into the new private block. At 560, the replier has the option of creating one or more additional private branches via one or more additional private blocks with one or more private messages as described above in acts 544-552. At 564, after the user is finished adding blocks and content to the blocks, one or more unique component messages are generated for the public and private blocks as described in detail above in connection with FIG. 3.

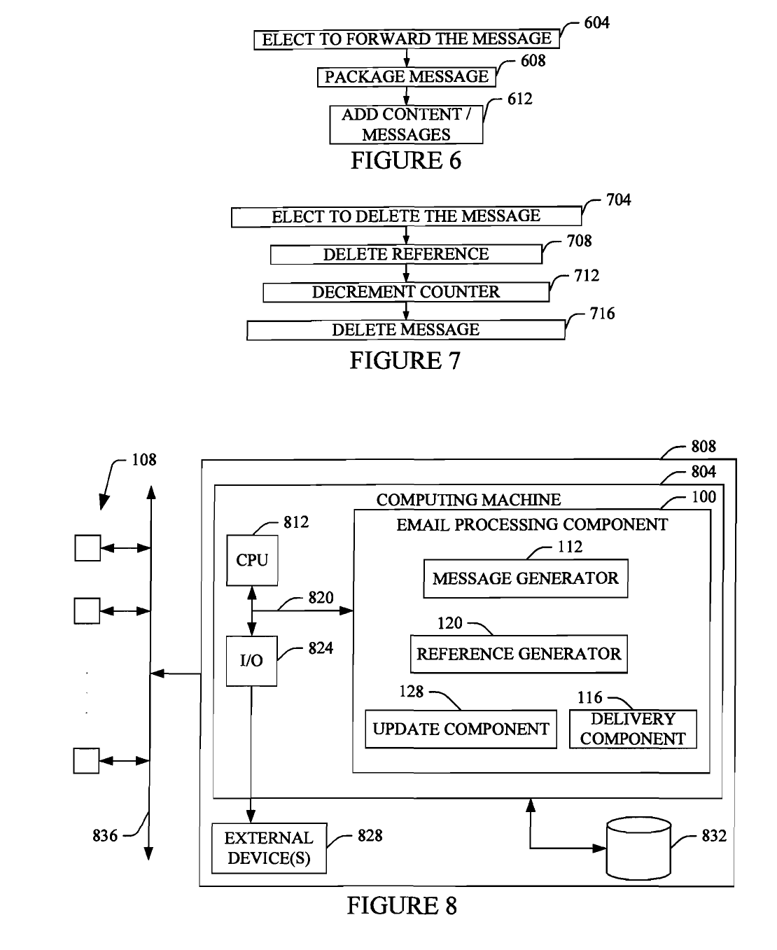

Additionally or alternatively, a recipient may forward the message as described next in FIG. 6. At 604, the recipient elects to forward a received message. At 608, the content of the received message is inserted into a public block of a new email message that will be forwarded. At 612, the recipient continues to prepare the email as described above in connection with FIG. 2, for example, by adding content to the public block and/or one or more private messages.

Additionally or alternatively, the recipient may delete a reference to a message as described next in FIG. 7. At 704, the recipient elects to delete the message. At 708, the recipient deletes the reference to the message. At 712, the reference counter is decremented. At 716, when all the references are deleted, the message may be deleted since there is no longer any active discussion. Note that messages can exist in different discussions. For example, a user may forward a private discussion to a subset of users to begin a new branching discussion. Those blocks are included in each discussion. However, the content generally is stored only one time. When the references for both discussions are deleted, the content is deleted.

Referring next to FIG. 8, an exemplary computerized implementation includes a computing machine 804 deployed within a computer infrastructure 808 such as that existing with the email processing component 104 described above. This is intended to demonstrate, among other things, that the systems and methods herein could be implemented within a network environment (e.g., the Internet, a wide area network (WAN), a local area network (LAN), a virtual private network (VPN), etc.), or on a stand-alone computer system.

In the case of the former, communication throughout the network can occur via any combination of various types of communication links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 808 is intended to demonstrate that some or all of the components of system 100 could be deployed, managed, serviced, etc. by a service provider who offers to implement, deploy, and/or perform the functions described herein for others.

As shown, the computing machine 804 includes a processing unit 812, a memory 816, a bus 820, and input/output (I/O) interfaces 824. Further, the computer system 804 is shown in communication with external I/O devices/resources 828 and storage system 832. In general, the processing unit 812 executes computer program code, such as the code to implement the email processing component 104, which is stored in memory 816 and/or storage system 832. It is to be appreciated that two or more, including all, of these components may be implemented as a single component.

While executing computer program code, the processing unit 812 can read and/or write data to/from the memory 816, the storage system 832, and/or the I/O interfaces 824. The bus 820 provides a communication link between each of the components in computer system 804. The external devices 828 can comprise any devices (e.g., keyboard, pointing device, display, etc.) that enable a user to interact with computing machine 804 and/or any devices (e.g., network card, modem, etc.) that enable computing machine 804 to communicate with one or more other computing devices.

The computer infrastructure 808 is only illustrative of various types of computer infrastructures for implementing the systems and methods described herein. For example, in one embodiment, computer infrastructure 808 comprises two or more computing devices (e.g., a server cluster) that communicate over a network to perform the various process acts. Moreover, computing machine 804 is only representative of various possible computer systems that can include numerous combinations of hardware.

To this extent, in other embodiments, computing machine 804 can comprise any specific purpose-computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Moreover, the processing unit 812 may comprise a single processing unit, or be distributed across one or more processing units in one or more locations, e.g., on a client and server. Similarly, the memory 816 and/or the storage system 832 can comprise any combination of various types of data storage and/or transmission media that reside at one or more physical locations.

Further, I/O interfaces 824 can comprise any system for exchanging information with one or more of the external devices 828. Still further, it is understood that one or more additional components (e.g., system software, math co-processing unit, etc.) not shown in FIG. 8 can be included in computing machine 804. However, if computing machine 804 comprises a handheld device or the like, it is understood that one or more of the external devices 828 (e.g., a display) and/or the storage system 832 could be contained within computing machine 804, not externally as shown.

The storage system 832 can be any type of system (e.g., a database) capable of providing storage for information. To this extent, the storage system 832 could include one or more storage devices, such as a magnetic disk drive or an optical disk drive. In another embodiment, the storage system 832 includes data distributed across, for example, a local area network (LAN), wide area network (WAN) or a storage area network (SAN) (not shown). Further, although not shown, additional components, such as cache memory, communication systems, system software, etc., may be incorporated into computing machine 804.

Shown in the memory 816 of computing machine 804 is the email processing component 104, which includes the message generator 112, the reference generator 120, the update component 128, and the delivery component 116. Although not shown as such one or more clients 108 may also be included in the memory 816. In another implementation, two or more of these components, including all of the components, can be a single component. In the illustrated embodiment, the clients 108 interact with the computing systems 836 via a path 836. These components perform the functions discussed above.

While shown and described herein via exemplary methods and systems, it is understood that various alternatives are contemplated. For example, another embodiment, a computer-readable/useable medium includes computer program code to enable a computer infrastructure to process multi-vectored email messages as discussed herein. To this extent, the computer-readable/useable medium includes program code that implements each of the various acts.

It is understood that the terms computer-readable medium or computer useable medium comprise one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as the memory 816 and/or the storage system 832 (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, a business method performs the acts described herein on a subscription, advertising, and/or fee basis. That is, a service provider could offer to manage the email processing component 104. In this case, the service provider can create, maintain, support, etc., a computer infrastructure, such as the computer infrastructure 808 that performs the acts for one or more customers. In return, the service provider can receive payment from the customer(s) under a subscription and/or fee agreement and/or the service provider can receive payment from the sale of advertising content to one or more third parties.

In still another embodiment, a computer-implemented method for executing the email processing component 104 is contemplated. In this case, a computer infrastructure, such as computer infrastructure 808, can be provided and one or more systems for performing the acts can be obtained (e.g., created, purchased, used, modified, etc.) and deployed to the computer infrastructure. To this extent, the deployment of a system can comprise one or more of installing program code on a computing device, such as computing machine 804, from a computer-readable medium, adding one or more computing devices to the computer infrastructure, and incorporating and/or modifying one or more existing systems of the computer infrastructure to enable the computer infrastructure to perform the methods descried herein.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects has been presented for purposes of illustration and description. It is not intended to be exhaustive or limiting to the precise form disclosed and, obviously, many modifications and variations are possible. Such modifications and variations that may be apparent to a person skilled in the art are intended to be included within the scope as defined by the accompanying claims.

Still yet, any of the components described herein could be deployed, managed, serviced, etc. by a service provider who offers to such email processing.

We claim:

1. A system, comprising:
a processor that separates a single email message into a public message component and at least one private message component, and
memory operative to the processor that stores the public message component and the at least one private message component;
wherein the single email message includes a public message block having a public message for a plurality of public recipients and at least one private message block having a private message for at least one private message recipient, wherein the at least one private message recipient is a subset of the plurality of public recipients, and
wherein the public message component includes the public message from the public message block and the private message component includes the public message and the at least one private message from the public message block and the private message block.

2. The system of claim 1, further including a component that generates a unique reference for the stored public message component and for each of the at least one private message components.

3. The system of claim 2, wherein the public message component is accessed via the unique reference for the public message component, and a private message component is accessed via a unique reference to the private message component.

4. The system of claim 2, wherein a stored message component is deleted from the memory after each of the message recipients deletes the corresponding unique reference.

5. The system of claim 1, wherein the stored public and at least one private message components are respectively updated to include public and private message replies.

6. The system of claim 1, wherein the memory is located on a server.

7. A method, comprising:
separating an email message having a public message block and at least one private message block into a public message component that includes the public message block and at least one private message component in which each private message component includes the public message block and a corresponding private message block;
storing the public message component and the at least one private message component on a computer readable medium; and
providing access to the stored public and private message components by corresponding message recipients.

8. The method of claim 7, further including providing an interface for generating the email message having the public and at least one private blocks.

9. The method of claim 8, wherein the interface executes on a client machine.

10. The method of claim 8, wherein the interface executes on a server.

11. The method of claim 7, wherein each of the at least one private message blocks has a unique set of recipients that is a subset of the public messages block recipients.

12. The method of claim 7, further including accessing a stored message component via a unique reference to the stored message component.

13. The method of claim 7, further including generating 2ⁿ message components, wherein n is a number of private message blocks.

14. A computer readable storage medium having computer program code stored therein, the program code comprising instructions which, when executed:
separate an email message having a public message block and at least one private message block into a public message component that includes the public message block and at least one private message component, each including the public message block and a corresponding private message block; and
store the public message component and the at least one private message component in memory.

15. The computer readable storage medium of claim 14, wherein the instructions, when executed, further generate a unique reference to each of the stored message components.

16. The computer readable storage medium of claim 15, wherein the instructions, when executed, further cause each of the unique references to be delivered to a recipient of the message.

17. The computer readable storage medium of claim 15, wherein the instructions, when executed, further provide access to the stored message component via the corresponding unique reference.

18. A method, comprising:
providing computer executable program code to be deployed to and executed on a computer system, the program code comprising instructions which, when executed on the computer system:
parse an email message having a public message block and at least one private message block into a public message component that includes the public message block and a plurality of private message components that each include the public message block and a corresponding private message block; and
store the public message component and the plurality of private message components on computer readable medium.

19. The method of claim 18, wherein the instructions, when executed on the computer system, further provide access to the stored message component via authorized recipients.

20. The method of claim 18, wherein the instructions, when executed on the computer system, further allow a recipient to reply to, forward, and delete a reference to a stored message component.
